(19) United States
(12) Patent Application Publication
(10) Pub. No.: US 2010/0080643 A1
(43) Pub. Date: Apr. 1, 2010

(54) PRINTING PRESS AND OPERATING METHOD FOR THE SAME

(75) Inventors: Takahide Toshito, Hiroshima (JP); Akihiko Mizuno, Hiroshima (JP)

Correspondence Address: KANESAKA BERNER AND PARTNERS LLP, 1700 DIAGONAL RD, SUITE 310, ALEXANDRIA, VA, 22314-2848, US

(73) Assignee: Mitsubishi Heavy Industries Ltd, Tokyo (JP)

(21) Appl. No.: 12/444,765

(22) PCT Filed: Oct. 11, 2007
(86) PCT No.: PCT/JP2007/069828

§ 371 Date: Apr. 8, 2009

(30) Foreign Application Priority Data
Oct. 13, 2006 (JP) 2006 279934

(51) Int. Cl. B41J 11/00

(52) U.S. Cl. 400/621

(57) ABSTRACT

A printing press is provided in which reliable, automatic cutting control can be performed and can be made stable at an early stage so that spoiled paper can be reduced. A web offset press includes a cutting cylinder, a mark detector, a compensator roller, and a cut-off control unit having an exact-cutting control mode for adjusting cutting positions of a web by changing the position of the compensator roller on the basis of cutting timing and the detection timing of a cut mark detected in a gate signal having a predetermined relationship therewith. The cut-off control unit further has a rough-cutting control mode in which the mark detector detects a mark set for the entire surface of the web, and the position of the compensator roller is changed on the basis of a deviation between the detection timing of the mark and the cutting timing so that the cut-mark-detection timing falls within the gate signal.

### TECHNICAL FIELD

The present invention relates to a printing press suitable for use in cutting a printed web at a predetermined position and a method for operating the same.

### BACKGROUND ART

For example, as shown in Patent Document 1, conventional web offset presses or the like are provided with a web cut-off control unit that controls the cutting position so as to prevent cutting misalignment in the running direction of a web when cutting the web in its width direction after subjecting the web to printing.

This controls the cutting position by using a cut mark printed on the web (specifically, a cut register mark, hereinafter simply referred to as a cut mark).

A compensator roller is vertically moved on the basis of a reference pulse sent from an encoder that rotates in synchronization with a cutting cylinder of a folding unit so that the timing at which the web is cut with the cutting cylinder and the timing at which the cut mark is detected by a mark detector mounted at a fixed position match or have a predetermined difference.

Since the phase of the web relative to the rotation phase of the cutting cylinder can be finely adjusted by finely adjusting the running path length of the web using the vertical movement of the compensator roller, the cutting position of the printed product can be held at a fixed position.

In Patent Document 1, the cut mark is printed in the vicinity of the end of the web and laterally outside a picture, so that the picture is decreased in size correspondingly.

In recent years, there has been a demand for printing a picture portion in a large size. To respond to such a demand, a device in which a cut mark is printed between printed pictures and within an extended area of the pictures or a device in which an appropriate cut mark is set in a picture to save the amount of ink used has been proposed.

In these cases, particularly in the latter case, the position of the cut mark changes in the width direction of the web, so that the lateral position of a mark detector needs to be changed; therefore, an operator must find a position at which the mark detector can detect the mark by moving the mark detector in the width direction of the web by hand or remote control, which takes much time. Furthermore, since the web runs continuously until the mark detector is disposed at an appropriate position, the amount of wasted paper is increased as the above operation takes much time.

Thus, as shown in Patent Document 2, the inventors of the present application have proposed a technique for controlling the lateral position of a mark detector before printing in accordance with the lateral position of a cut mark.

This technique involves converting the resolution of image data for plate making or image data processed from image data for plate making to the resolution of a mark detector, calculating a position on a web where a cut mark is present from the converted image data, and, based on the calculated cut-mark position, moving the mark detector to the calculated position of the cut mark in the width direction of the web before printing. This allows the cut mark on the web to be detected at the beginning of printing, allowing a web cutting position to be held fixed, thereby remarkably reducing the amount of wasted paper.

In this case, the initial position of the compensator roller and cut-mark detection timing were set to values expected to be optimum at production speed so as to start cutting control at the start of printing.

In particular, in the case of setting an appropriate cut mark in a picture, a part similar to the set cut mark is present in the entire length of the picture, which increases the probability of misrecognizing that part as the cut mark.

This misrecognition of the part similar to the cut mark causes the cutting position to be displaced from a predetermined position, which results in a corresponding amount of wasted paper.

Therefore, a device has been proposed which detects a set cut mark in a specified limited region in the vicinity of the cut mark to reduce misrecognition of a part similar to the cut mark.

Patent Document 1: Japanese Unexamined Patent Application, Publication No. Hei 8-174804

Patent Document 1: Japanese Unexamined Patent Application, Publication No. 2004-82279

### DISCLOSURE OF INVENTION

In printing presses, operations, such as reserve supply of ink, color-tone adjustment, and registration adjustment, are performed while running a web at low speed before starting printing (operation at production speed).

Webs change in tension according to the printing environment, such as the type (basis weight) of paper used in printing and paper drawing speed, and thus change in the degree of extension; therefore, the running path lengths thereof often change in those operation regions as compared with those at production speed.

Therefore, the position of a compensator roller for providing an accurate cutting position changes slightly.

In an extreme instance, this causes a situation in which the cut mark is not located in the specified region even if the initial position of the compensator roller and cut-mark detection timing are set to values expected to be optimum at production speed so that cutting control is started at the start of printing.

In the case of the first paper threading route (printing conditions include a difference in paper threading route), there is no information about the position of the compensator roller. This causes a situation, almost certainly, in which even the initial position thereof cannot be set, so that the cut mark is not located in the specified region.

The absence of the cut mark in the specified region prevents automatic cutting control, resulting in manual control.

Therefore, at a speed lower than production speed, it takes much time to perform cutting-position adjustment at a speed lower than production speed because of cutting misalignment due to changes in the compensator position, and it takes much time to perform stable cutting control, thus generating much wasted paper.

Although various measures have been considered, sufficient measures are not available at present.

The present invention has been conceived in light of the problems described above, and an object thereof is to provide a printing press that is capable of automatic cutting control with certainty and that can be brought to a stable state at an early stage so that the amount of wasted paper can be reduced, as well as a method for operating the same.

To solve the above problems, the present invention employs the following solutions.

Specifically, a first aspect of the present invention provides a printing press including a cut-off unit that cuts a running printed web in a width direction at predetermined cutting timing; a mark detector that is provided upstream of the cut-off unit in a web running direction and that detects cut marks on the web; a compensator roller that is provided upstream of the mark detector in the web running direction and that changes the running-path length of the web by moving in position; and a cut-off control unit having an exact-cutting control mode for adjusting the cutting position of the web by changing the position of the compensator roller on the basis of the cutting timing and the timing at which the cut mark is detected in a specified region having a predetermined relationship therewith, wherein, the cut-off control unit further has a rough-cutting control mode in which the mark detector detects a mark registration portion set for the entire surface of the web, and the position of the compensator roller is changed on the basis of a deviation between the detection timing of the mark registration portion and the cutting timing so that the cut mark detection timing falls within the specified region.

According to this aspect, the cut-off control unit uses the exact-cutting control mode to control the position of the compensator roller on the basis of the difference between the timing at which the web is cut with the cut-off unit and the timing at which the cut mark is detected by the mark detector and adjusts the web cutting position with the cut-off unit by changing the running path length of the web by moving the position of the compensator roller.

At that time, if there is no compensator-roller set position under the new printing conditions or if webs change greatly in tension there is no cut mark in the specified region having a predetermined positional relationship with the cutting timing. In this case, because no cut mark can be detected, cutting control cannot be performed using the exact-cutting control mode.

In this case, the cut-off control unit executes control using the rough-cutting control mode in such a manner that it sets a mark registration portion having a predetermined relationship with the cutting position for the entire surface of the web; the mark detector detects this mark registration portion; and the position of the compensator roller is changed on the basis of a deviation between the mark-registration-portion detection timing and the cutting timing so that the mark detection timing falls within the specified region.

When the cut-mark detection timing falls within the specified region, the cut-off control unit can perform cutting control using the exact-cutting control mode.

Since the mark registration portion is thus set for the entire surface of the web, the mark detector can reliably detect it even if cutting misalignment is large.

Accordingly, the rough-cutting control mode allows the mark registration portion to be reliably detected, which permits the cut-mark detection timing to fall within a specified region using it, and then it can be followed by the exact-cutting control mode.

This ensures automatic cutting control. This can make cutting control stable earlier than by manual control, thereby reducing the amount of wasted paper during that time.

In the above aspect, it is preferable that the cut-off control unit use, as the mark registration portion, a mark printed on non-picture portions that are continuously present along the web running direction.

Since no picture is printed upstream and downstream of the mark in the running direction, this configuration causes a large difference in signal level; thus the mark detector can reliably detect the mark.

This mark may be used as a cut mark.

In the above aspect, it is preferable that the cut-off control unit use, as the mark registration portion, a specific portion in each of pictures on the web.

Since the mark registration portion is a specific portion in each picture on the web, this configuration allows the mark detector to reliably detect the mark registration portion.

In this case, for reliable detection, it is preferable that the specific portion be set at a portion where a margin that is long upstream and/or downstream in the running direction is present, for example, at an end of each picture in the running direction, at which the margin between the pictures can be used.

The specific portion may be used as a cut mark.

In the above aspect, it is preferable that the cut-off control unit use, as the mark registration portion, a spoiled-portion gap.

The spoiled-portion gap means a margin that is present between adjacent pictures in a spoiled state.

In particular, at the beginning of printing, ink is dispersed over the entire surface of the printing plate because of the unstable balance between the ink and dampening water, which causes a spoiled-portion gap on a web to which it is transferred in which the entire portion corresponding to the printing plate is stained.

Thus, such a spoiled picture and a margin at a spoiled-portion gap significantly differ in signal level, which allows the mark detector to reliably detect the spoiled-portion gap.

Even in circumstances such as the inability to perform printing on the entire length of the margins at both sides of the web or the absence of appropriate specific portions in the pictures, the spoiled-portion gap can be formed, which ensures implementation of the rough-cutting control mode.

In this case, for example, the supply of dampening water may be reduced so as to forcibly generate spoiled paper due to ink staining.

In the above aspect, it is preferable that the cut-off control unit appropriately select and use, as the mark registration portion, a mark printed on non-picture portions that are continuously present along the web running direction, a specific portion in each of pictures on the web, or a spoiled-portion gap.

This allows the form of specific portions to be selected in accordance with situations such as the inability to perform printing on non-picture portions which continue along the web running direction, the absence of appropriate specific portions in the pictures, the formation of no spoiled paper because adjustment of dampening-water amount needs to be speeded up, etc. Therefore, the rough-cutting control mode can reliably be executed, and a print job responsive to user needs can be executed.

In the above aspect, it is preferable that the cut-off control unit implement the rough-cutting control mode for new printing conditions.

Under the new printing conditions, there is no information on the positions of the compensator rollers and therefore their initial positions cannot be set, thus often causing a situation in which no cut mark is located in the specified region.

The configuration to implement the rough-cutting control mode under the new printing conditions eliminates the need for checking whether cut-mark detection timing is within the specified region, thus allowing reliable cutting control to be performed correspondingly earlier.

The “new printing condition” here translates mainly to a first paper threading route not before used.

A second aspect of the present invention provides a method for operating a printing press equipped with a cut-off unit for cutting a running printed web in a width direction at predetermined cutting timing; a mark detector that is provided upstream of the cut-off unit in a web running direction and that detects cut marks on the web; a compensator roller that is provided upstream of the mark detector in the web running direction and that changes the running-path length of the web by moving in position; and a cut-off control unit having an exact-cutting control mode for adjusting the cutting position of the web by changing the position of the compensator roller on the basis of the cutting timing and the detection timing of the cut mark detected in a specified region having a predetermined relationship therewith, wherein, if the cut-mark detection timing is not detected in the specified region having a predetermined relationship with the cutting timing, the cut-off control unit is configured such that, using a rough-cutting control mode, the mark detector detects a mark registration portion set for the entire surface of the web, and the position of the compensator roller is changed on the basis of a deviation between the detection timing of the mark registration portion and the cutting timing so that the mark detection timing falls within the specified region.

According to this aspect, the cut-off control unit uses the exact-cutting control mode to control the position of the compensator roller on the basis of the difference between the timing at which the web is cut with the cut-off unit and the timing at which the cut mark is detected by the mark detector and adjusts the web cutting position with the cut-off unit by changing the running path length of the web by moving the position of the compensator roller.

At that time, if there is no compensator-roller set position under the new printing conditions or if webs change greatly in tension there is no cut mark in the specified region having a predetermined positional relationship with the cutting timing. In this case, because no cut mark can be detected, cutting control cannot be performed using the exact-cutting control mode.

In this case, the cut-off control unit executes control using the rough-cutting control mode in such a manner that it sets a mark registration portion having a predetermined relationship with the cutting position for the entire surface of the web; the mark detector detects this mark registration portion; and the position of the compensator roller is changed on the basis of a deviation between the mark-registration-portion detection timing and the cutting timing so that the mark detection timing falls within the specified region.

When the cut-mark detection timing falls within the specified region, the cut-off control unit can perform cutting control using the exact-cutting control mode.

Since the mark registration portion is thus set for the entire surface of the web, the mark detector can reliably detect it even if cutting misalignment is large.

Accordingly, the rough-cutting control mode allows the mark registration portion to be reliably detected, which permits cut-mark detection timing to fall within a specified region using it and permits the process to be followed by the exact-cutting control mode.

This ensures automatic cutting control. This can make cutting control stable earlier by manual control, thereby reducing the amount of wasted paper during that time.

A third aspect of the present invention provides a method for operating a printing press equipped with a cut-off unit that cuts a running printed web in a width direction at predetermined cutting timing; a mark detector that is provided upstream of the cut-off unit in a web running direction and that detects cut marks on the web; a compensator roller that is provided upstream of the mark detector in the web running direction and that changes the running-path length of the web by moving in position; and a cut-off control unit having an exact-cutting control mode for adjusting the cutting position of the web by changing the position of the compensator roller on the basis of the cutting timing and the timing at which the cut mark is detected in a specified region having a predetermined relationship therewith, wherein, under new printing conditions, the cut-off control unit is configured such that, using a rough-cutting control mode, the mark detector detects a mark registration portion set for the entire surface of the web, and the position of the compensator roller is changed on the basis of a deviation between the detection timing of the mark registration portion and the cutting timing so that the mark detection timing falls within the specified region.

According to this aspect, the cut-off control unit uses the exact-cutting control mode to control the position of the compensator roller on the basis of the difference between the timing at which the web is cut with the cut-off unit and the timing at which the cut mark is detected by the mark detector and adjusts the web cutting position with the cut-off unit by changing the running path length of the web by moving the position of the compensator roller.

In this case, for the new printing conditions, the cut-off control unit executes control using the rough-cutting control mode in such a manner that it sets a mark registration portion having a predetermined relationship with the cutting position for the entire surface of the web; the mark detector detects this mark registration portion; and the position of the compensator roller is changed on the basis of a deviation between the mark-registration-portion detection timing and the cutting timing so that the mark detection timing falls within the specified region.

When the cut-mark detection timing falls within the specified region, the cut-off control unit can perform cutting control using the exact-cutting control mode.

Since the mark registration portion is thus set for the entire surface of the web, the mark detector can reliably detect it even if cutting misalignment is large.

Accordingly, the rough-cutting control mode allows the mark registration portion to be reliably detected, which permits cut-mark detection timing to fall within a specified region using it, and then it can be followed by the exact-cutting control mode.

This ensures automatic cutting control. This can make cutting control stable earlier by manual control, thereby reducing the amount of wasted paper during that time.

This eliminates the need for checking whether cut-mark detection timing is within the specified region, thus allowing reliable cutting control correspondingly earlier.

According to the present invention, in the case where no cut mark is present in a specified region having a predetermined relationship with cutting timing, or the like, the cut-off control unit executes control using the rough-cutting control mode in such a manner that it sets a mark registration portion having a predetermined relationship with the cutting position for the entire surface of the web; the mark detector detects this mark registration portion; and the position of the compensator roller is changed on the basis of a deviation between the mark-registration-portion detection timing and the cutting timing so that the mark detection timing falls within the specified region, thus ensuring automatic cutting control. This can make cutting control stable earlier than by manual control, thereby reducing the amount of wasted paper during that time.

### BRIEF DESCRIPTION OF DRAWINGS

FIG. 1 is a schematic structural diagram schematically showing the whole of a web offset press 1 for printing newspaper according to an embodiment of the present invention.

FIG. 2 is a block diagram schematically showing, in outline, the configuration of parts included in a cut-off control unit according to an embodiment of the present invention.

FIG. 3A is a schematic diagram showing a state in which a printed web is cut well by a web offset press according to an embodiment of the present invention.

FIG. 3B is a schematic diagram showing a state in which a printed web is cut in a misaligned manner by a web offset press according to an embodiment of the present invention.

FIG. 4 is a schematic diagram showing marks and a mark sensor signal thereof in a rough-cutting control mode according to an embodiment of the present invention.

FIG. 5 is a schematic diagram showing specific portions and a mark sensor signal thereof in a rough-cutting control mode according to an embodiment of the present invention.

FIG. 6 is a schematic diagram showing spoiled-portion gaps and a mark sensor signal thereof in a rough-cutting control mode according to an embodiment of the present invention.

FIG. 7A is a flowchart showing the flow of a print job of a web offset press for printing newspaper according to an embodiment of the present invention.

FIG. 7B is a flowchart showing the flow of a print job of a web offset press for printing newspaper according to an embodiment of the present invention.

FIG. 8 is a graph showing changes in the production speed of a web offset press during a print job under new printing conditions.

FIG. 9 is a graph showing changes in the production speed of a web offset press during a print job under repeat printing conditions.

### EXPLANATION OF REFERENCE SIGNS

1: web offset press
13: web
41: compensator roller
43: mark detector
51: cutting cylinder
55: cut-off control unit
67: mark sensor signal
69: cut mark
71: picture
75: margin
81: gate signal
83: cutting position
85: rough-cutting control mode
87: fine-cutting control mode
89: mark
91: specific portion
93: spoiled-portion gap

### BEST MODE FOR CARRYING OUT THE INVENTION

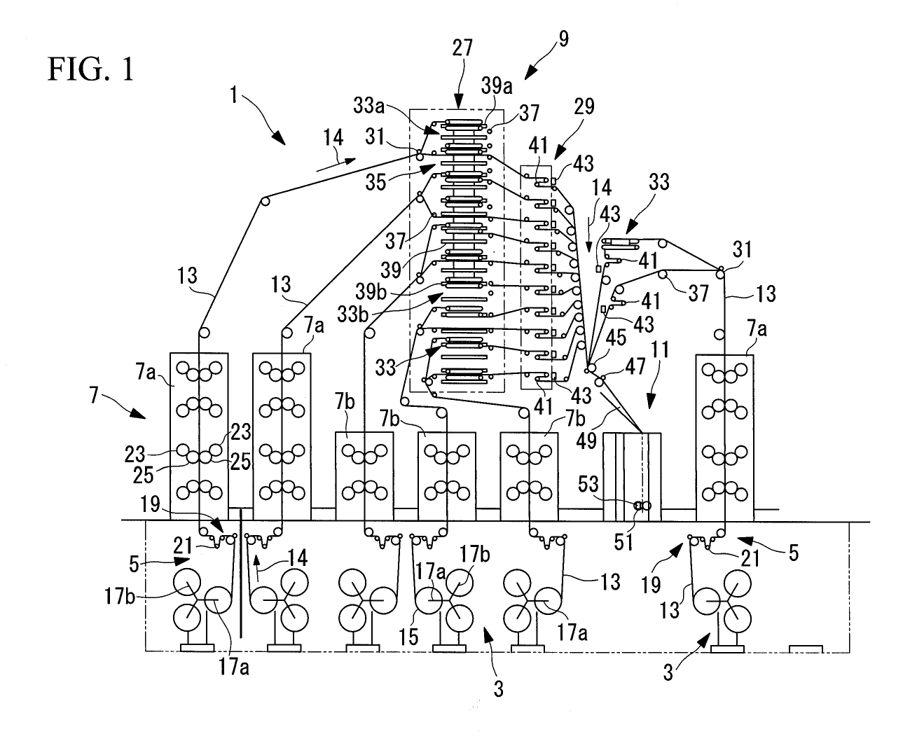

A web offset press (printing press) according to an embodiment of the present invention will be described with reference to FIGS. 1 to 9.

FIG. 1 is an outline structural diagram schematically showing the whole of a web offset press 1 for printing newspaper according to an embodiment of the present invention.

The web offset press 1 has a plurality of reel stand units 3, in-feed units 5, a printing unit 7, a turn-bar array unit 9, and a folding unit 11.

The reel stand units 3 each have three pairs of arms 17 that each rotatably hold a paper roll 15 around which a web 13 is wound into a roll and a paper splicer (not shown).

When the web 13 is fed from the paper roll 15 mounted to an arm 17b located at a paper feeding position, the paper roll 15 on an arm 17b located at a paper splicing position stands by while preparing for paper splicing.

When the remaining amount of the let-out web 13 on the paper roll 15 becomes small, it is spliced with the web 13 on the standby paper roll 15.

In this way, the web 13 is continuously let out from the reel stand unit 3 to the printing unit 7.

The in-feed units 5 each have an in-feed drag 19 and dancer rollers 21.

The in-feed drag 19 is a portion that continuously draws out the web 13 from the paper rolls 15 and is configured to be driven independently of the movement of the entire printing press. The in-feed drag 19 adopts a configuration to nip the web 13 with rollers.

The dancer rollers 21 are rollers that are disposed substantially perpendicular to the running direction 14 of the web 13 and parallel to the web 13. The dancer rollers 21 are elastically supported by air cylinders (not shown) in the vertical direction (that is, in a direction to come into and out of contact with the running surface of the web 13.

When the tension of the web 13 is low, the dancer rollers 21 are lowered by the air cylinders to increase the tension of the web 13, and when the tension of the web 13 is high, the dancer rollers 21 are raised against the air cylinders to decrease the tension of the web 13.

The printing unit 7 includes a multicolor printing unit 7a having four sets of printing sections for performing double-sided four-color printing and a two-color printing unit 7b having two sets of printing sections for performing double-sided two-color printing.

The printing sections are each provided with a plate cylinder 23 and blanket cylinder 25 pair, with the individual blanket cylinders 25 opposing each other with the web 17 interposed therebetween, to allow double-sided printing. The opposing blanket cylinders 25 function to apply print pressure to each other.

The plate cylinders 23 each have, on the circumferential surfaces, a dampening device and an ink device (not shown). The dampening devices supply dampening water to printing plates attached around the individual plate cylinders 23, and the ink devices supply ink to the printing plates.

In this embodiment, three multicolor printing units 7a and three two-color printing units 7b are provided. The multicolor printing units 7a are arranged such that there are two units at one side end (on the left in FIG. 1) and one unit at the other side (on the right in FIG. 1), with the folding unit 11 therebetween. The three two-color printing units 7b are arranged in parallel at one side of the folding unit 11.

The number and arrangement of the multicolor printing units 7a and the two-color printing units 7b are not limited to these; they may be provided in any number and arrangement.

Although the multicolor printing units 7a and the two-color printing units 7b are each wide enough to allow printing of four pages of newspaper, generally, a four-page width, they can print at a one-page width, a two-page width, a three-page width, or any other width by changing the widths of the web 13 and the printing plates.

Although not shown, automatic register control sensors are provided at the individual outlets of the multicolor printing units 7a and the two-color printing units 7b.

The automatic register control sensors detect the individual color-shift amounts, and circumferential-register motors (not shown) provided for the individual plate cylinders 23 are driven to correct registration according to the detected register error amounts, thereby bringing the register error amounts close to zero.

The turn-bar array unit 9 includes a turn-bar unit 27 and a compensator unit 29.

The turn-bar unit 27 includes slitters 31, a plurality of sets of turn-bar devices 33, a guide roller group 35, and a plurality of inlet guide rollers 37.

The plurality of slitters 31 are provided vertically at the inlet of the turn-bar unit 27. The slitters 31 each cut the web 13 fed from the multicolor printing units 7a or the two-color printing units 7b.

The plurality of turn-bar devices 33 are provided in the vertical direction. The turn-bar devices 33 are each constituted of a plurality of turn bars, which are disposed at an angle of substantially 45° and parallel to the web 13, and have the function of overlaying the slit webs 13 one on the other or changing the running direction 14 of the web 13 to the width direction of the web offset press 1.

The guide roller group 35 is constituted of a plurality of guide rollers 39 that are disposed at intervals on both sides (or only one side) of the plurality of turn-bar devices 33 and whose axes extend in the longitudinal direction of the web offset press 1.

The plurality of inlet guide rollers 37 are provided at appropriate locations such that their axes extend in the width direction of the web offset press 1 to guide the individual webs 13 to predetermined paths.

FIG. 1 illustrates a state in which, of the slit webs 13, the running path of the one guided upward is displaced in the width direction by the turn-bar devices 33 and one is stacked on the other one which is guided downward.

The running direction 14 of the web 13 guided to the uppermost turn-bar device 33a is changed to the width direction of the web offset press 1, is in turn changed to a substantially perpendicular direction (so as to be directed downward) by a guide roller 39a, is then wound around a lower guide roller 39b so as to be turned toward a turn-bar device 33b, and is displaced in the width direction by the turn-bar device 33b and stacked on the other web 13.

This is one example. The order in which the webs 13 are stacked one on another is configured to be suitably adjusted using the turn-bar devices 33 and the guide roller group 35.

The compensator unit 29 includes a plurality of compensator rollers 41 disposed at intervals in the vertical direction and a plurality of mark detectors 43 disposed at the outlets of the individual compensator rollers 41.

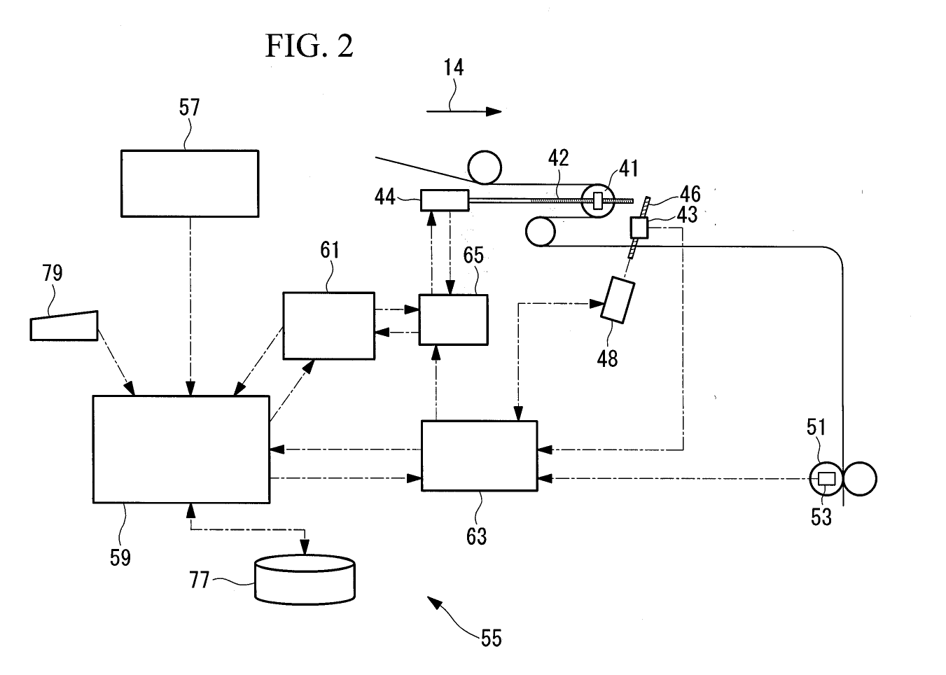

The compensator rollers 41 extend in the direction substantially perpendicular to the running direction 14 of the webs 13. A compensator threaded shaft 42, extending substantially in the running direction, is screwed into one end of the compensator rollers 41 (see FIG. 2).

The compensator threaded shaft 42 is configured to be rotated by a compensator motor 44 so as to move the compensator roller 41 screwed thereon toward the running path of the web 13 to bring it into and out of contact with the web 13 (laterally in FIG. 1), thereby changing the running path length of the web 13 (see FIG. 2).

A driving means for each compensator roller 41 may be an appropriate means such as a hydraulic cylinder.

In FIG. 1, the control direction of the compensator rollers 41 is set to the lateral direction; however, it is sometimes set to a different direction (for example, a vertical direction) depending on the disposition of the compensator rollers 41, in other words, the running direction 14 of the webs 13.

In short, it is sufficient that the running path lengths of the webs 13 can be adjusted by moving the compensator rollers 41.

The mark detectors 43 are mounted in the vicinity of the guide rollers downstream in the running direction 14 of the compensator rollers 41 in such a manner that measuring portions face the webs 13.

A sensor threaded shaft 46, extending substantially in the width direction, is screwed in each of the mark detectors 43 (see FIG. 2).

The sensor threaded shaft 46 is configured to be rotated by a sensor motor 48 so as to move the mark detector 43 screwed thereon in the width direction of the web 13 (see FIG. 2).

The mark detectors 43 are constituted of photodiodes or the like for detecting light, which radiate light to the individual running webs 13, convert the amount (intensity) of light reflected from the webs to voltage, and output it as a mark sensor signal 67.

Also for the web 13 fed from the multicolor printing unit 7a located at the right of the folding unit 11 in FIG. 1, the slitter 31, the turn-bar device 33, the inlet guide rollers 37, the compensator rollers 41, and the mark detectors 43 are provided.

In this way, the webs 13 slit and arranged in a predetermined order at the turn-bar array unit 9 are fed to the folding unit 11.

The webs 13 at the folding unit 11 are fed to a former plate 49 while being given tension by a first paper drawing device 45 and a second paper drawing device 47. The webs 13 are longitudinally folded in two by the former plate 49, thereafter pass through lead-in rollers, nipping rollers and so on, and are cut at a predetermined position with a cutting cylinder (cut-off unit) 51. Thereafter, they are folded into a desired signature and are transported to the outside.

The cutting cylinder 51 is configured to cross the web 13 once per one rotation.

The cutting cylinder 51 includes, on its shaft, a rotary encoder 53 that outputs a reference pulse and a clock pulse every one rotation of the cutting cylinder 51.

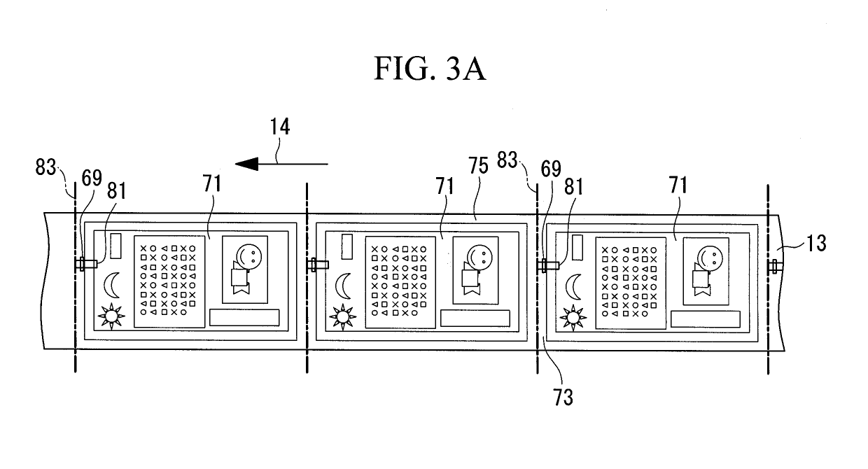

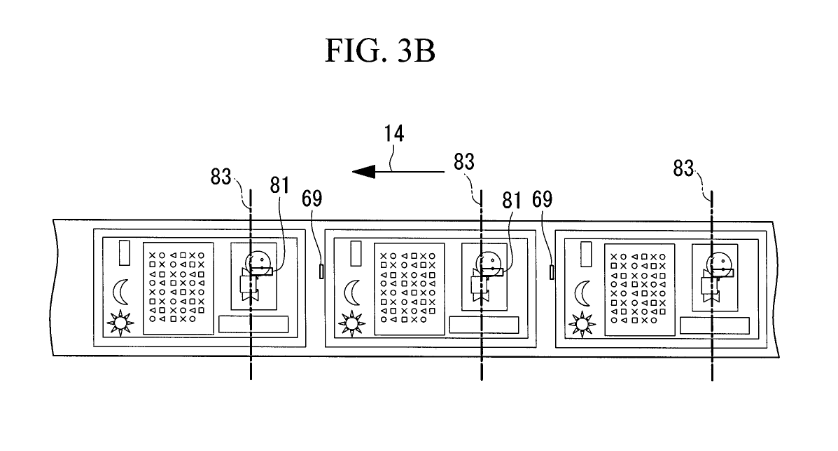

FIG. 2 is a block diagram schematically showing, in outline, the configuration of parts included in a cut-off control unit 55. FIG. 3A is a schematic diagram showing a state in which the printed web 13 is cut well. FIG. 3B is a schematic diagram showing a state in which the printed web 13 is cut in a misaligned manner.

As shown in FIGS. 3A and 3B, the web 13 has pictures 71 printed repeatedly at predetermined intervals. Accordingly, on the web 13, margins 73, which are basically not printed, are formed between the adjacent pictures 71, and margins (full-length margins) 75, which are basically not printed and continue in the running direction 14 of the web 13, are formed on both sides of each picture 71 (both lateral sides of the web 13).

FIGS. 3A and 3B show a state in which cut marks 69 are printed on the individual margins 73. The cut marks 69 are sometimes printed on the margins 75 or are set at appropriately selected portions of the pictures 71.

The cut-off control unit 55 is composed principally of a lithographic-image position recognition system 57, an printing-condition management system 59, a printing press control unit 61, a cut-off controller 63, and a compensator-roller driving control unit 65.

The lithographic-image position recognition system 57 has the function of, for example, processing image data acquired from a plate-making process, setting the cut marks 69, and calculating the lateral positions and running-direction positions thereof on the web 13.

The lithographic-image position recognition system 57 transmits the cut-mark positions, image positions, and print-job information, such as the newspaper page configuration, to the printing-condition management system 59.

The printing-condition management system 59 includes an printing-condition data storage unit 77.

The printing-condition data storage unit 77 stores printing conditions of the past printing jobs in association with registration numbers for the individual different printing conditions. Examples of the different printing conditions include the printing unit 7a or 7b to be used and a paper threading route through which the web 13 from the printing unit 7a or 7b passes.

For example, the compensator rollers 41 to be used and the adjusted positions thereof are stored for each of the different printing conditions.

The control desk 79 is for inputting an instruction to the printing-condition management system 59. With the control desk 79, printing conditions such as the printing unit 7a or 7b to be used and its paper threading route are selected and transmitted to the printing-condition management system 59.

The control desk 79 allows operations such as selecting the number of copies or starting the automatic operation of the compensator rollers 41, according to which an instruction is transmitted to the printing-condition management system 59.

The printing-condition management system 59 receives printing conditions from the control desk 79 and print-job information from the lithographic-image position recognition system 57 and performs layout to the individual printing sections of the plates and assignment of the compensator rollers 41 according to the layout. The printing-condition management system 59 then transmits positional information on the cut marks 69 and positional information on the mark detectors 43 based thereon to the cut-off controller 63.

The printing-condition management system 59 determines whether the same printing condition as an instructed paper threading route is present in the printing conditions of the past print jobs stored in the printing-condition data storage unit 77.

If the same printing condition is present in the printing conditions of the past print jobs, the printing-condition management system 59 sets this printing condition as a repeat printing condition, and if the same printing condition is not present, it sets this printing condition as a new printing condition.

The printing-condition management system 59 has the function of, for a repeat printing condition, transmitting the adjustment positions of the compensator rollers 41 stored in the printing-condition data storage unit 77 to the printing press control unit 61, to be described later, as a preset position thereof. The printing-condition management system 59 has the function of transmitting the other printing conditions, such as production speed, cylinder impression ON, attachment/detachment of the dampening device, to the printing press control unit 61.

It further has the function of receiving present-position information on the compensator rollers 41 from the printing press control unit 61, automatically storing one at the end of a print job, and for a new printing condition, registering it as new storage data including the printing condition.

The printing-condition management system 59 has the function of determining and deciding a method for rough cutting control, which will be described later.

The printing press control unit 61 controls the overall operations of the web offset press 1, such as the production speed, cylinder impression ON, and the attachment/detachment of the dampening device of the web offset press 1. The control operations include the function of instructing the compensator-roller driving control unit 65 to move the compensator rollers 41 according to an instruction on the preset positions of the compensator rollers 41 from the printing-condition management system 59.

The printing press control unit 61 has the function of receiving information on the present positions of the compensator rollers 41 from the compensator-roller driving control unit 65 and transmitting it to the printing-condition management system 59.

The cut-off controller 63 has the function of generating a compensator-roller cutting control instruction for adjusting the positions of the compensator rollers 41 so that a deviation between a reference signal from the rotary encoder 53 and detection signals of marks on the webs 13, for example, the cut marks 69, falls within a predetermined range and transmitting it to the compensator-roller driving control unit 65 to perform cutting control of the webs 13.

This cutting control includes a fine-cutting control mode (exact-cutting control mode) 85 and a rough-cutting control mode 87.

Which of the fine-cutting control mode 85 and the rough-cutting control mode 87 is to be used is determined by the printing-condition management system 59 and the cut-off controller 63.

The cut-off controller 63 has the function of generating a gate signal 81 that rises at timing obtained from the reference pulse and plate mark positions and that continues for a predetermined period by introducing a reference pulse and a clock pulse from the rotary encoder 53.

This timing is set, as shown in FIGS. 3A and 3B, for example, so as to rise at the rising edges of the reference pulse, that is, at positions upstream, for example, 3 mm, from the cutting positions 83 in the running direction 14 of the web 13. The generating period is set to correspond to a length of about 21 mm of the web 13.

These timing and generating period are merely examples, which are set as appropriate according to various conditions.

Since mark detection in the fine-cutting control mode 85 is performed only during a period when the gate signal 81 is generated, the cut marks 69 may be set as specific marks during the period in which the gate signal 81 is generated, for example, within the length of 21 mm.

On the other hand, the rough-cutting control mode 87 is used when the cut marks 69 are not present or may not be present during the period when the gate signal 81 is generated. Therefore, mark detection in the rough-cutting control mode 87 is performed continuously along the running direction 14 of the web 13, and therefore, specific marks are set between adjacent cutting positions 83.

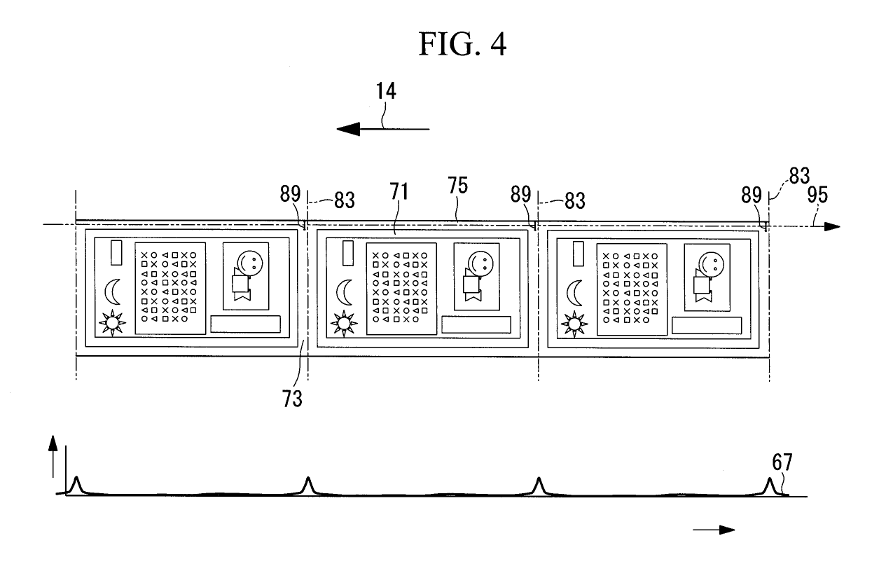

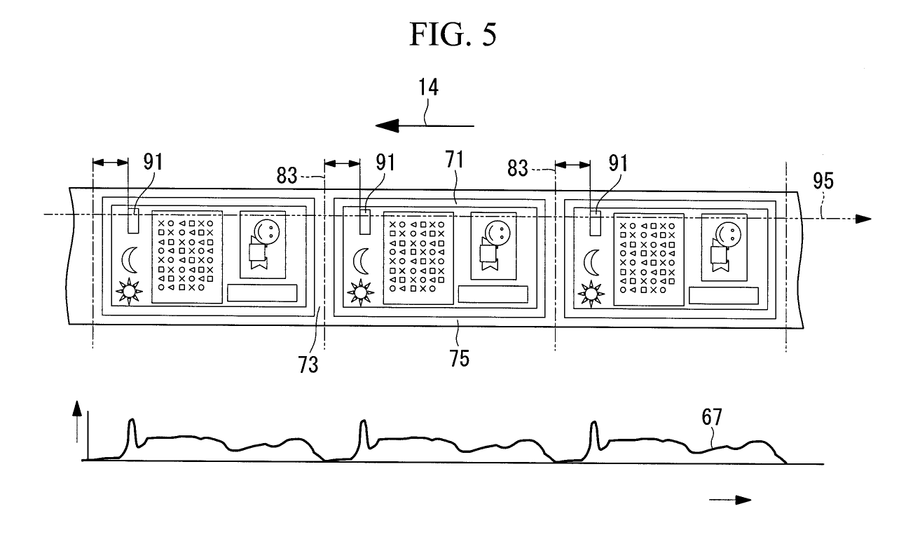

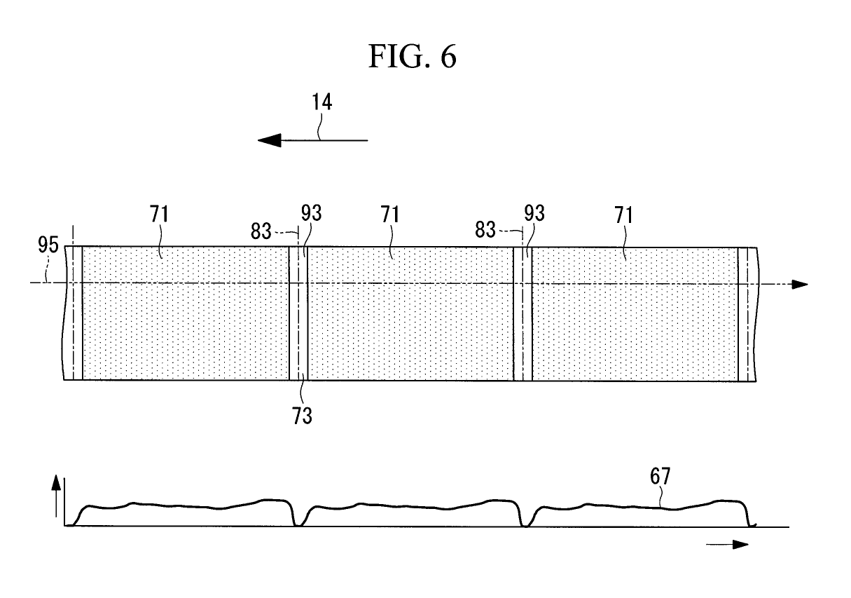

Examples of such specific marks include marks (mark registration portions) 89 printed on the margins 75, shown in FIG. 4, specific portions (mark registration portions) 91 in the pictures 71, as shown in FIG. 5, and spoiled-portion gaps (mark registration portions) 93, as shown in FIG. 6.

The margins 75 are marginal spaces that are present continuously along the running direction 14 of the web 13 and are basically not printed (that is, portions having no picture 71 along the circumference of the plate).

As shown in FIG. 4, when a sensing line 95 of the mark detector 43 is positioned to detect marks 89, the signal level of a mark sensor signal 67 significantly differs between the marks 89 and the other portions because the upstream side and the downstream side of the marks 89 are not printed.

This allows the mark detector 43 to reliably detect the marks 89.

For the specific portions 91, distinctive portions, on the circumference of the plate, along the sensing line 95 of the mark detector 43 are selected and set.

For example, as shown in FIG. 5, portions which are present at the ends of the pictures 71 close to the margins 73, at which the mark sensor signal 67 rises to the maximum value along the sensing line 95, are selected.

Thus, since portions at which the level of the mark sensor signal 67 is low, i.e., the margins 73, are present in the vicinity of the specific portions 91, the difference from the signal level of the specific portions 91 can be discriminated more clearly, so that the mark detectors 43 can reliably detect the specific portions 91.

The specific portions 91 need not necessarily be set at the ends of the pictures 71 but may be set at portions that the mark detectors 43 can reliably detect from the entire surface of the pictures 71.

In this case, it is preferable to ascertain the phase difference between the set specific portions 91 and the cutting positions 83 from image data or the like.

When plates are mounted on the corresponding plate cylinders 23, mounting gaps are present at the mounting portions. Since these gaps are, of course, not stained with ink, no ink is transferred to the portions of the webs 13 corresponding to these gaps even when the pictures 71 are transferred to the webs 13. That is, they constitute part of the margins 73.

At the beginning of printing, spoiled portion, i.e., print stain, occurs in which ink is dispersed across the printing plate because of the imbalance between the ink and dampening water, so that the part of the web 13, corresponding to the printing plate, to which the dispersed ink is transferred becomes stained as a whole (see FIG. 6).

The spoiled-portion gap 93 refers to the above-described gap at that time. The signal level of the mark sensor signal 67 differs significantly between the pictures 71 in a spoiled state and the spoiled-portion gap 93 to which no ink is transferred, as shown in FIG. 6.

This allows the mark detector 43 to reliably detect the spoiled-portion gaps 93 in a fixed positional relationship with the cutting positions 83.

The cut-off controller 63 has the function of driving the sensor motors 48 according to positional information on the mark detectors 43 from the printing-condition management system 59 to change the lateral position of the mark detectors 43 to the positions of marks, for example, the cut marks 69.

The cut-off controller 63 is configured to calculate how long the mark detectors 43 have moved from their reference positions from the rotational speed of the sensor motors 48, measured by a potentiometer or the like (not shown), the widths of the threaded grooves of the sensor threaded shafts 46, and the like to estimate the present positions of the mark detectors 43 in the width direction of the webs 13.

During the execution of cutting control, the compensator-roller driving control unit 65 drives the compensator motors 44 according to a compensator-roller cutting control instruction from the cut-off controller 63 to rotate the compensator threaded shafts 42 to thereby move the positions of the mark detectors 43, thus adjusting the running-path lengths of the webs 13.

At that time, the compensator-roller driving control unit 65 calculates how long the compensator rollers 41 have moved from their reference positions from the rotational speeds of the compensator motors 44, measured by a potentiometer (not shown), the widths of the threaded grooves of the compensator threaded shafts 42 and the like to estimate the present positions of the compensator rollers 41.

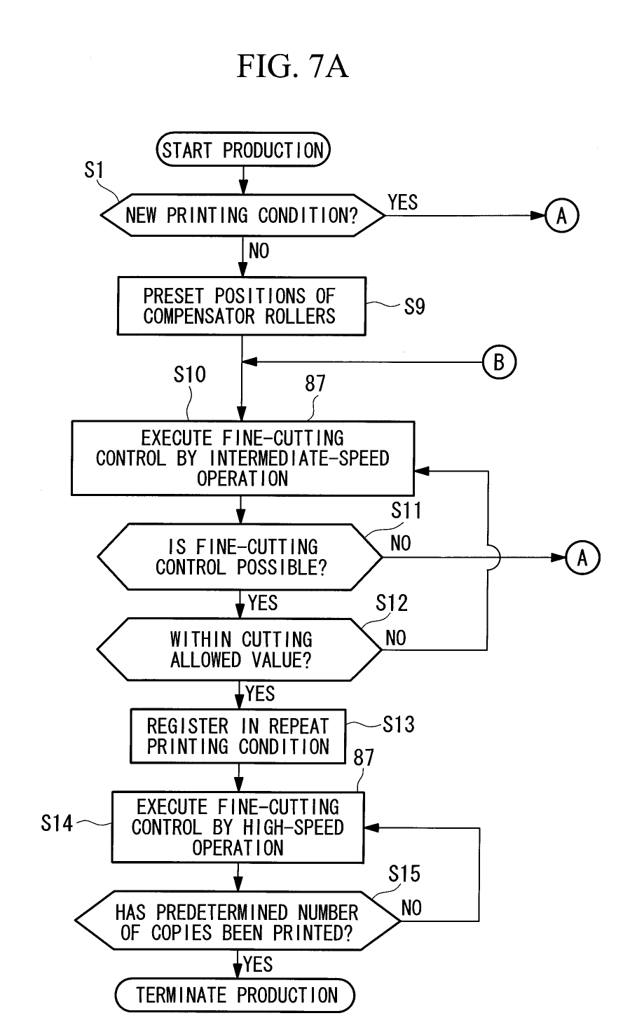

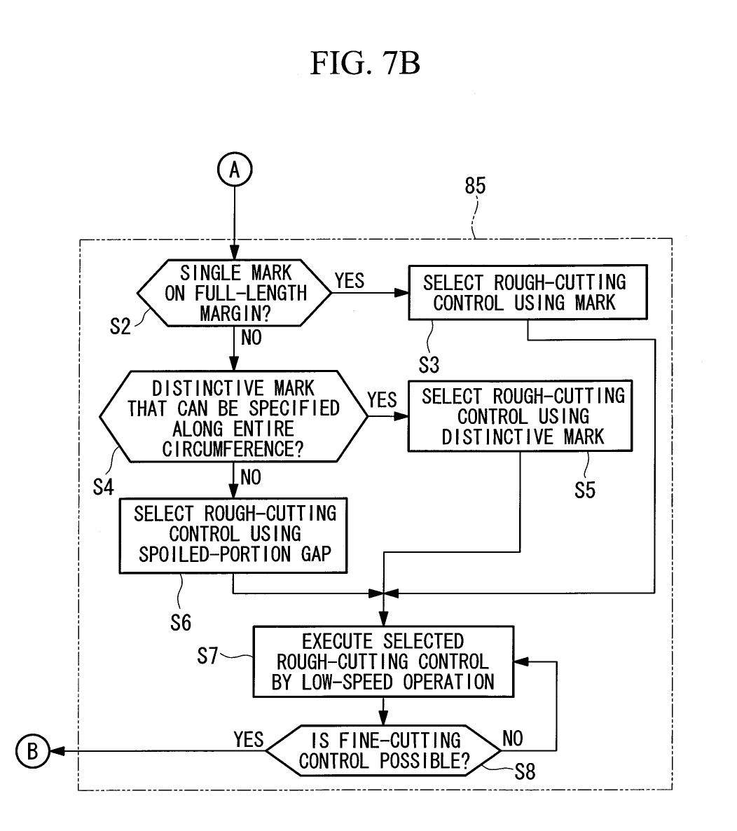

The printing operation, principally cutting control, of the web offset press 1 according to this embodiment with this configuration will be described with reference to FIGS. 7 to 9.

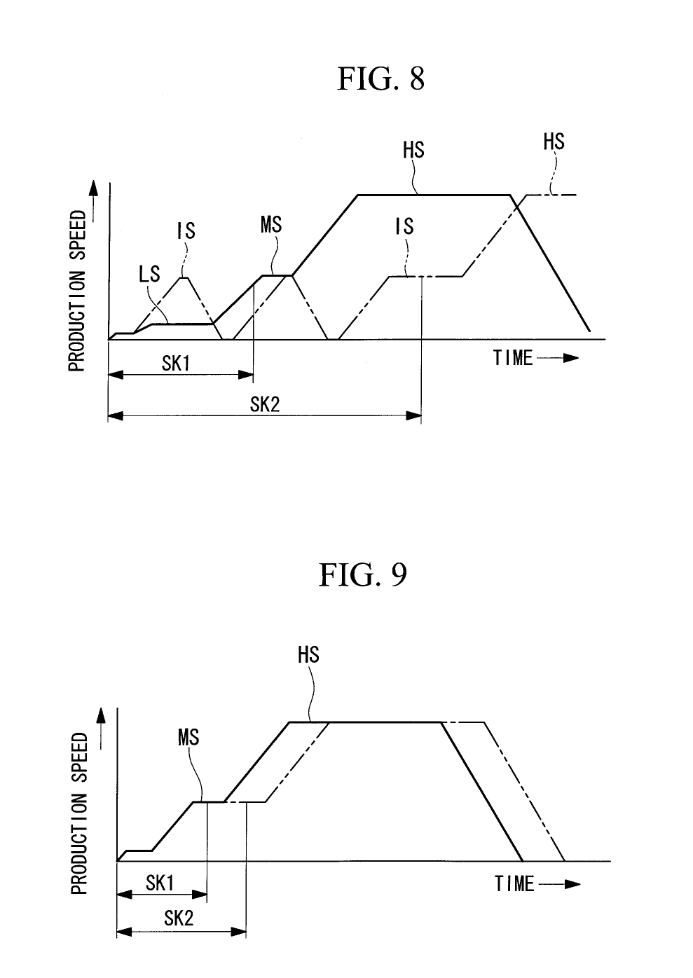

FIGS. 7A and 7B are flowcharts showing the flow of a print job. FIG. 8 is a graph showing changes in the production speed of the web offset press 1 during a print job under new printing conditions. FIG. 9 is a graph showing changes in the production speed of the web offset press 1 during a print job under repeat printing conditions.

First, the details of this print job, that is, printing conditions, such as the printing unit 7a or 7b to be used, a paper threading route, paper type, and the number of copies, are input at the control desk 79.

The lithographic-image position recognition system 57 sets the cut marks 69 for a plate used in this print job from image data thereof.

At that time, the lithographic-image position recognition system 57 determines whether marks are present on the margins 75; if they are present, it sets them as the marks 89. In this case, if the cut marks 69 are present on the margins 75, they may be set as the marks 89.

If the marks 89 cannot be set, the lithographic-image position recognition system 57 determines whether the specific portions 91 can be set on the pictures 71 from the image data; if they can be set, it sets the specific portions 91, and if they cannot be set, it provides a signal indicating that setting is impossible.

The setting of the marks 89 and the specific portions 91 may be performed at another timing.

The printing conditions input to the control desk 79 and the positional information on the cut marks 69 and so on set by the printing-condition management system 59 are sent to the printing-condition management system 59.

The printing-condition management system 59 receives the printing conditions from the control desk 79 and print-job information from the lithographic-image position recognition system 57 and assigns plates to the individual plate cylinders of the printing unit 7a or 7b to be used. It also assigns the compensator rollers 41 according to the web paper threading routes from the individual printing unit 7a or 7b.

The printing-condition management system 59 determines whether the same printing condition as an instructed paper threading route is present in the printing conditions of the past print jobs stored in the printing-condition data storage unit 77 (step S1).

If the same printing condition is not present, that is, if it is a new printing condition (YES), the printing-condition management system 59 enter the rough-cutting control mode 85 (see FIG. 7B).

The printing-condition management system 59 determines whether there is setting information of the marks 89 in the information sent from the lithographic-image position recognition system 57 (step S2).

If there is setting information of the marks 89 (YES), rough-cutting control using the marks 89 is selected (step S3), and positional information on the marks 89 is acquired.

If there is no setting information of the marks 89 (NO), it is determined whether there is setting information of the specific portions 91 in the information sent from the lithographic-image position recognition system 57 (step S4).

If there is setting information of the specific portions 91 (YES), rough-cutting control using the specific portions 91 is selected (step S5), and positional information on the specific portions 91 is acquired.

If there is no setting information of the specific portions 91 (NO), rough-cutting control using the spoiled-portion gaps is selected (step S6).

In accordance with the rough-cutting control method selected in this way, the printing-condition management system 59 transmits the positional information on the cut marks 69 and the marks 89 and the specific portions 91 or the spoiled-portion gaps, and the positional information on the mark detectors 43 based thereon to the cut-off controller 63.

The cut-off controller 63 moves the mark detectors 43 to lateral positions, as necessary, at which the marks 89, the specific portions 91, or the spoiled-portion gap can be detected, according to the positional information.

On the other hand, the printing-condition management system 59 transmits necessary printing conditions to the printing press control unit 61 that controls the overall operation of the web offset press 1 and starts driving the web offset press 1.

When the web offset press 1 is driven, the webs 13 are drawn from the reel stand units 3 by the in-feed units 5 and are fed to the printing unit 7, with their tension adjusted.

At first, the webs 13 are transported at a substantially fixed low speed (see FIG. 8), during which reserve ink supply, a paper threading operation, and the like are performed, as needed.

Thereafter, the webs 13 are increased in speed, during which cylinder impression ON is performed at the printing sections of the individual printing units 7a or 7b, and the pictures 71 are printed on both sides of the webs 13 at the printing sections 7.

The webs 13 printed by the individual printing units 7a or 7b are transported to the turn-bar array unit 9.

Each of the webs 13 sent to the turn-bar array unit 9 is slit by the slitter 3 at the turn-bar unit 27. The running direction 14 of one of the slit webs 13 is changed in the width direction of the web offset press 1 by the turn-bar devices 33 and overlaid on the other slit web 13.

The overlaying order of part of the slit webs 13 is adjusted using the turn-bar devices 33 and the guide roller group 35.

The webs 13 whose overlaying order and lateral positions are adjusted in this way are individually wound around the compensator rollers 41 of the compensator unit 29, are overlaid in layers, and are transported to the folding unit 11.

The webs 13 are given tension by the first paper drawing device 45 and the second paper drawing device 47 and are transported to the former plate 49. After being longitudinally folded by the former plate 49 into two, the webs 13 pass through the lead-in rollers and the nipping rollers and are cut in the width direction at predetermined positions with the cutting cylinder 51. After that, they are folded into a desired signature and are transported to the outside.

After the cylinder impression ON, the webs 13 are transported at a substantially constant low-speed printing region LS (see FIG. 8), and the cut-off controller 63 starts rough-cutting control by the rough-cutting control method selected in step S3, S5, or S6 (step S7).

That is, if rough-cutting control using the marks 89 is selected, the cut-off controller 63 generates a compensator-roller cutting control instruction so that the phase difference between the detection timing of the marks 89 and a reference pulse from the rotary encoder 53 falls within a predetermined range and transmits it to the compensator-roller driving control unit 65.

This predetermined range is set so that the detection signal for the cut marks 69 falls within a period during which the gate signal 81 is generated.

The compensator-roller driving control unit 65 adjusts the positions of the compensator rollers 41 according to the compensator-roller cutting control instruction to change the running-path lengths of the webs 13 so that the mark detectors 43 can detect the cut marks 69.

If rough-cutting control using the specific portions 91 is selected, the cut-off controller 63 generates a compensator-roller cutting control instruction so that the phase difference between the detection timing of the specific portions 91 and the reference pulse from the rotary encoder 53 falls within a predetermined range and transmits it to the compensator-roller driving control unit 65.

If rough-cutting control using the spoiled-portion gap 93 is selected, the cut-off controller 63 generates a compensator-roller cutting control instruction so that the phase difference between the detection timing of the spoiled-portion gaps and the reference pulse from the rotary encoder 53 falls within a predetermined range and transmits it to the compensator-roller driving control unit 65.

Also in those cases, the compensator-roller driving control unit 65 adjusts the positions of the compensator rollers 41 according to this compensator-roller cutting control instruction to change the running-path lengths of the webs 13 so that the mark detectors 43 can detect the cut marks 69.

While cut-off controller 63 executes the rough-cutting control in this way, the cut-off controller 63 determines whether the cut marks 69 can be detected within a period during which the gate signal 81 is generated, at all times or every predetermined period (step S8); if they cannot be detected (NO), the cut-off controller 63 continues the rough-cutting control.

If they can be detected (YES), the webs 13 are increased in speed to an intermediate-speed printing region MS.

On the other hand, in step S1, if there is no new printing condition (NO) but there is the same printing condition, that is, a repeat printing condition, the printing-condition management system 59 transmits the positions of the compensator rollers, adjusted in the previous print job and registered in the compensator-roller driving control unit 65, as preset values through the printing press control unit 61 (see FIG. 7A).

The compensator-roller driving control unit 65 presets the positions of the compensator rollers 41 to those preset values (step S9).

The printing-condition management system 59 transmits the necessary printing conditions to the printing press control unit 61 that controls the overall operation of the web offset press 1 to start driving the web offset press 1.

The web offset press 1 performs the same print preparatory operation as in the foregoing rough-cutting control mode and accelerates the webs 13 to the intermediate-speed printing region MS faster than the low-speed printing region LS after the cylinder impression ON (see FIG. 9).

In this way, when the moving speed of the webs 13 reaches the intermediate-speed printing region MS in the case of YES in step S8 and after step S9, the webs 13 are set at substantially fixed speed, and the fine-cutting control mode 87 is performed.

The cut-off controller 63 generates the gate signal 81 so that it has a predetermined relationship with the reference pulse from the rotary encoder 53, generates a compensator-roller cutting control instruction so that the phase difference between the timing at which the cut marks 69 are detected within a period during which the gate signal 81 is generated and the reference pulse falls within a predetermined range and transmits it to the compensator-roller driving control unit 65.

The predetermined range is set so that the cutting-position misalignment relative to the predetermined cutting positions 83 falls within a cutting allowed value, for example, ±3 to 4 mm.

The compensator-roller driving control unit 65 adjusts the positions of the individual compensator rollers 41 according to this compensator-roller cutting control instruction to change the running path lengths of the webs 13 and executes the fine-cutting control mode 87 so that their cutting positions are located at predetermined cutting positions (step S10).

While the cut-off controller 63 executes the fine-cutting control in this way, the cut-off controller 63 determines whether the cut marks 69 can be detected within a period during which the gate signal 81 is generated, at all times or at predetermined intervals (step S11).

If they cannot be detected (NO), the fine-cutting control cannot be continued, and therefore, the process is returned to the rough-cutting control mode 85, that is, step S2. In this case, the rough-cutting control mode 85 is executed, with the production speed of the web offset press 1 held at the intermediate-speed printing region MS, and when the cut marks 69 can be detected within a period during which the gate signal 81 is generated, the process is returned to the fine-cutting control mode 87.

In contrast, if they can be detected (YES), it is determined whether the cutting-position misalignment relative to the predetermined cutting positions 83 falls within a cutting allowed value, that is, whether it can be shipped as a fine product (step S12).

If the cutting-position misalignment relative to the predetermined cutting position 83 is out of the cutting allowed value (NO), the fine-cutting control is continued.

If the cutting-position misalignment relative to the predetermined cutting position 81 falls within the cutting allowed value (YES), it is determined that cutting control is being executed well.

In this case, as a repeat operation condition, the printing-condition management system 59 automatically registers the positions of the compensator rollers 41, which are sent from the compensator-roller driving control unit 65, as adjusted cutting positions (step S13).

The positions of the compensator rollers 41 in a high-speed printing region HS, to be described later, may be registered as a repeat operation condition.

The printing press control unit 61 increases the production speed to the high-speed printing region HS (see FIGS. 8 and 9) and performs a print job while continuing the fine-cutting control mode 87 (step S14).

During that time, the printing-condition management system 59 determines whether the number of copies has reached a predetermined number (step S15); if it has not reached the predetermined number (NO), the print job is continued.

If the number of copies has reached the predetermined number (YES), the printing-condition management system 59 gives a print termination instruction, and the printing press control unit 61 proceeds to a print termination procedure.

In this way, under new printing conditions without data to preset the positions of the compensator rollers 41, the cut marks 69 cannot usually be detected within a period in which the gate signal 81 is generated. In this case, the rough-cutting control mode 87 allows the cut marks 69 to be automatically detected within the period during which the gate signal 81 is generated.

At that time, the rough-cutting control mode 85 uses the marks 89 printed on the margins 75, the distinctive specific portions 91 in the pictures 71, or the spoiled-portion gaps 93, so that the mark detectors 43 can reliably detect them.

Since the marks 89 printed on the margins 75, the distinctive specific portions 91 in the pictures 71, or the spoiled-portion gaps 93 are used, the form of specific portions can be selected in accordance with situations such as the inability to perform printing on non-picture portions which continue along the web running direction, the absence of appropriate specific portions in the pictures, formation of no spoiled paper because adjustment of dampening-water amount needs to be speeded up, etc. Therefore, the rough-cutting control mode 85 can reliably be executed, and a print job responsive to user needs can be executed.

Under the repeat printing condition, the positions of the compensator rollers 41 can be preset, so that most of the cut marks 69 can be detected within a period during which the gate signal 81 is generated. Under the new printing conditions, cutting control is performed using the fine-cutting control mode 87 after the cut marks 69 can be detected within the period during which the gate signal 81 is generated by the rough-cutting control mode 85. At that time, it is always checked whether the cut marks 69 can be detected within the period during which the gate signal 81 is generated, and if they cannot be detected, the process is returned to the rough-cutting control mode 85, which ensures automatic cutting control.

Since cutting control is thus performed automatically, cutting-position misalignment can be made within the cutting allowed value at an early stage. This can reduce a spoiled-paper period (that is, a preparatory period) SK1, thus reducing the amount of wasted paper and a print-job time.

FIG. 8 is a graph showing a comparison between the production state of the web offset press 1 according to this embodiment and that of a conventional one under the new printing conditions.

With the conventional one, for the conventional printing conditions, the process of performing trial printing, measuring the amount of cutting-position misalignment with the operation halted, and manually adjusting the positions of the compensator rollers 41 is repeated at least two or three times so that the cut marks 69 come within the range of the gate signal 81, and thus a spoiled-paper period (that is, a preparatory period) SK2 is longer than that of this embodiment.

In addition to the cutting control, for example, color-tone adjustment is performed. In this case, to perform color-tone feedback early, the production speed must be high, for example, in the intermediate printing region MS, which will increase the amount of wasted paper correspondingly.

FIG. 9 shows a case of repeat printing conditions. In this case, with the conventional one, the positions of the compensator rollers 41 are also preset at adjusted positions in the previous job, which only needs manual fine adjustment, thus causing not so great a difference compared with under the new printing conditions; however, individual fine adjustment of the plurality of webs 13 results in a wasted-paper period longer than that of this embodiment in which they are automatically adjusted all at once.

Although an embodiment of the present invention has been described above, the present invention is not limited thereto; various modifications can be made without departing from the spirit of the present invention.

For example, the above-described embodiment is configured to determine whether or not there are new printing conditions at the start of printing; if there are new printing conditions, the rough-cutting control mode 85 is automatically used. This determination may be omitted.

That is, under new printing conditions, it is possible that the positions of the compensator rollers 41 are set at provisional positions (for example, adjusted positions under repeat printing conditions similar thereto), the fine-cutting control mode 87 in step S10 is implemented, and as a result, if fine-cutting control cannot be performed in step S11, the process may shift to the rough-cutting control mode 85.

Although the foregoing embodiments are configured such that the marks 89 printed on the margins 75, the distinctive specific portions 91 in the pictures 71, and the spoiled-portion gaps 93 are selectively used as specific portions for the rough-cutting control mode 85 so as to cope with various printing modes, the rough-cutting control mode 85 that can cope with any one or two of those specific portions may be used provided that the printing form of the web offset press 1 can be specified.

1. A printing press comprising:
cutting means for cutting a running printed web in a width direction at predetermined cutting timing;
a mark detector that is provided upstream of the cutting means in a web running direction and that detects cut marks on the web;
a compensator roller that is provided upstream of the mark detector in the web running direction and that changes the running-path length of the web by moving in position; and
a cut-off control unit having an exact-cutting control mode for adjusting the cutting position of the web by changing the position of the compensator roller on the basis of the cutting timing and the detection timing of the cut mark detected in a specified region having a predetermined relationship therewith,
wherein, the cut-off control unit further has a rough-cutting control mode in which the mark detector detects a mark registration portion set for the entire surface of the web, and the position of the compensator roller is changed on the basis of a deviation between the detection timing of the mark registration portion and the cutting timing so that the mark detection timing falls within the specified region.

2. The printing press according to claim 1, wherein the cut-off control unit uses, as the mark registration portion, a mark printed on non-picture portions that are continuously present along the web running direction.

3. The printing press according to claim 1, wherein the cut-off control unit uses, as the mark registration portion, a specific portion in each of pictures on the web.

4. The printing press according to claim 1, wherein the cut-off control unit uses, as the mark registration portion, a spoiled-portion gap.

5. The printing press according to claim 1, wherein the cut-off control unit appropriately selects and uses, as the mark registration portion, a mark printed on non-picture portions that are continuously present along the web running direction, a specific portion in each picture on the web, or a spoiled-portion gap.

6. The printing press according to claim 1, wherein the cut-off control unit implements the rough-cutting control mode for new printing conditions.

7. A method for operating a printing press equipped with
cutting means for cutting a running printed web in a width direction at predetermined cutting timing;
a mark detector that is provided upstream of the cutting means in a web running direction and that detects cut marks on the web;
a compensator roller that is provided upstream of the mark detector in the web running direction and that changes the running-path length of the web by moving in position; and
a cut-off control unit having an exact-cutting control mode for adjusting the cutting position of the web by changing the position of the compensator roller on the basis of the cutting timing and the detection timing of the cut mark detected in a specified region having a predetermined relationship therewith,
wherein, if the cut-mark detection timing is not detected in the specified region having a predetermined relationship with the cutting timing, the cut-off control unit is configured such that, using a rough-cutting control mode, the mark detector detects a mark registration portion set for the entire surface of the web, and the position of the compensator roller is changed on the basis of a deviation between the detection timing of the mark registration portion and the cutting timing so that the mark detection timing falls within the specified region.

8. A method for operating a printing press equipped with
cutting means for cutting a running printed web in a width direction at predetermined cutting timing;
a mark detector that is provided upstream of the cutting means in a web running direction and that detects cut marks on the web;
a compensator roller that is provided upstream of the mark detector in the web running direction and that changes the running-path length of the web by moving in position; and
a cut-off control unit having an exact-cutting control mode for adjusting the cutting position of the web by changing the position of the compensator roller on the basis of the cutting timing and the detection timing of the cut mark detected in a specified region having a predetermined relationship therewith,
wherein, under new printing conditions, the cut-off control unit is configured such that, using a rough-cutting control mode, the mark detector detects a mark registration portion set for the entire surface of the web, and the position of the compensator roller is changed on the basis of a deviation between the detection timing of the mark registration portion and the cutting timing so that the mark detection timing falls within the specified region.

9. The printing press according to claim 2, wherein the cut-off control unit implements the rough-cutting control mode for new printing conditions.

10. The printing press according to claim 3, wherein the cut-off control unit implements the rough-cutting control mode for new printing conditions.

11. The printing press according to claim 4, wherein the cut-off control unit implements the rough-cutting control mode for new printing conditions.

12. The printing press according to claim 5, wherein the cut-off control unit implements the rough-cutting control mode for new printing conditions.
